(19) United States
(12) Patent Application Publication
(10) Pub. No.: US 2025/0298558 A1
(43) Pub. Date: Sep. 25, 2025

(54) INFORMATION PROCESSING SYSTEM, NON-TRANSITORY COMPUTER READABLE MEDIUM, AND CONTROL METHOD

(71) Applicant: FUJIFILM Business Innovation Corp., Tokyo (JP)

(72) Inventor: Ryoto YABUSAKI, Kanagawa (JP)

(73) Assignee: FUJIFILM Business Innovation Corp., Tokyo (JP)

(21) Appl. No.: 18/768,741

(22) Filed: Jul. 10, 2024

(30) Foreign Application Priority Data
Mar. 21, 2024 (JP) 2024-045736

(51) Int. Cl. G06F 3/12

(52) U.S. Cl. CPC G06F 3/1212; G06F 3/1256

(57) ABSTRACT

An information processing system includes a processor configured to transition, when requests for performing processing from a plurality of users have been detected, from a first operation mode to a second operation mode under which a number of operation procedures required from authentication of a user to execution of processing is smaller than a number of operation procedures required under the first operation mode.

### CROSS-REFERENCE TO RELATED APPLICATIONS

This application is based on and claims priority under 35 USC 119 from Japanese Patent Application No. 2024-045736 filed Mar. 21, 2024.

### BACKGROUND

### (i) Technical Field

The present disclosure relates to an information processing system, a non-transitory computer readable medium, and a control method.

### (ii) Related Art

Japanese Unexamined Patent Application Publication No. 2018-034341 discloses an information processing apparatus that, when a user has been authenticated, and when a status of use of the use is to be presented, controls whether or not to present the status of use of the user in accordance with a number of requests for performing processing, which have been provided by another user than the user.

### SUMMARY

Aspects of non-limiting embodiments of the present disclosure relate to provision of an information processing system, a non-transitory computer readable medium, and a control method capable of shortening a utilization period of time by a user during a busy period of time than a utilization period of time by the user during a non-busy period of time.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to transition, when requests for performing processing from a plurality of users have been detected, from a first operation mode to a second operation mode under which a number of operation procedures required from authentication of a user to execution of processing is smaller than a number of operation procedures required under the first operation mode.

### BRIEF DESCRIPTION OF THE DRAWINGS

An exemplary embodiment of the present disclosure will be described in detail based on the following figures, wherein:

FIG. 1 is a diagram illustrating a system configuration of an image forming system according to the exemplary embodiment of the present disclosure;

FIG. 2 is a block diagram illustrating a hardware configuration of an image forming apparatus according to the exemplary embodiment of the present disclosure;

FIG. 3 is a block diagram illustrating a functional configuration of the image forming apparatus described above;

FIG. 4 is a diagram for explaining screen transition under a normal mode;

FIG. 5 is a diagram for explaining screen transition under a busy mode;

FIG. 6 is a diagram for explaining screen transition under the normal mode;

FIG. 7 is a diagram for explaining screen transition under the busy mode;

FIG. 8 is a diagram illustrating an example of a preview screen under the normal mode;

FIG. 9 is a diagram illustrating an example of a preview screen under the busy mode;

FIG. 10 is a flowchart for explaining a flow of processing when executing a job in the image forming apparatus; and

FIG. 11 is a flowchart for explaining a flow of processing when a preview is displayed in the image forming apparatus.

### DETAILED DESCRIPTION

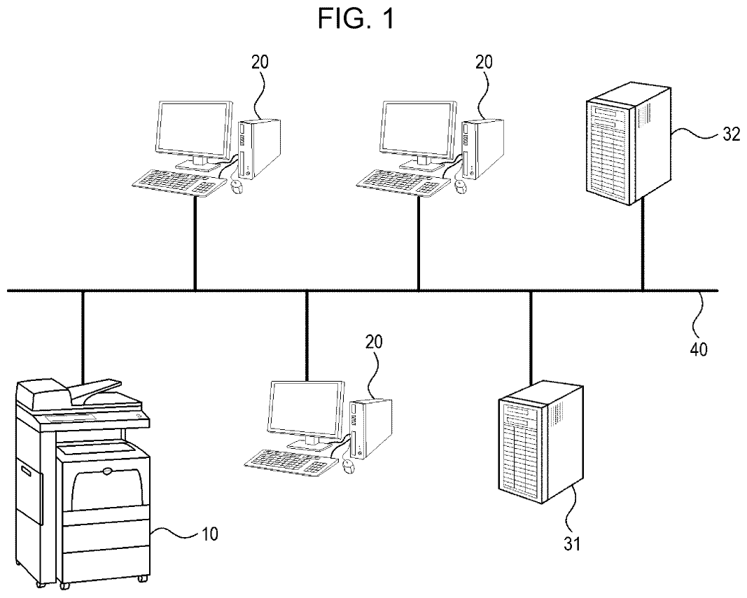

Example forms for implementing the technique of the present disclosure will now be described herein in detail with reference to the accompanying drawings. FIG. 1 is a diagram illustrating a system configuration of an image forming system according to an exemplary embodiment.

As illustrated in FIG. 1, the image forming system according to the present exemplary embodiment includes an image forming apparatus 10, a plurality of user terminals 20, an authentication server 32, and a print server 31. The image forming apparatus 10, the plurality of user terminals 20, the authentication server 32, and the print server 31 are coupled to each other via a network 40 such as a local area network (LAN).

The image forming apparatus 10 is a so-called multifunction machine having a plurality of functions such as a copying function, a printing function, a facsimile function, and a scanning function. The image forming apparatus 10 is an example of an information processing system in the technique of the present disclosure.

The user terminals 20 are terminals for using the functions of the image forming apparatus 10.

The authentication server 32 is a server for performing authentication of a user utilizing the image forming apparatus 10.

The print server 31 is a server for accumulating and managing print jobs for the image forming apparatus 10, which are transmitted from the plurality of user terminals 20.

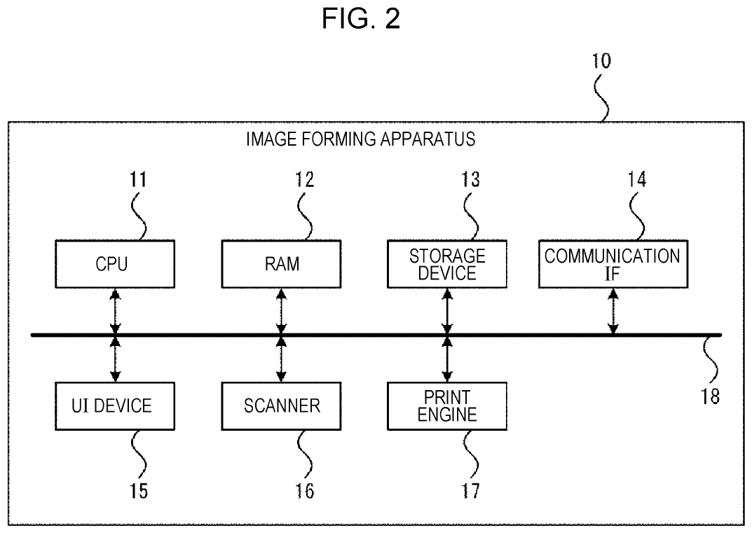

FIG. 2 is a block diagram illustrating a hardware configuration of the image forming apparatus 10. As illustrated in FIG. 2, the image forming apparatus 10 includes a central processing unit (CPU) 11, a random access memory (RAM) 12, a storage device 13 such as a hard disk drive, a communication interface (abbreviated as IF) 14, a user interface (abbreviated as UI) device 15, a scanner 16, and a print engine 17. These components are coupled to each other via a control bus 18.

The CPU 11 is a processor that executes predetermined processing based on a program stored in the RAM 12 or the storage device 13 to control operation of the image forming apparatus 10. Note that, although it has been described in the present exemplary embodiment that the CPU 11 reads and executes a program stored in the RAM 12 or the storage device 13, the present invention is not limited to the exemplary embodiment. The program may be provided in a form where the program is recorded on a computer-readable recording medium. For example, the program may be provided in a form where the program is recorded in an optical disc such as a compact disc (CD)-read only memory (ROM) or a digital versatile disc (DVD)-ROM, or in a form where the program is recorded in a semiconductor memory such as a universal serial bus (USB) memory or a memory card. Furthermore, the program may be acquired from an external device via a communication line coupled to the communication IF 14.

The communication IF 14 allows data to be transmitted to and received from an external device or the like via the network 40. The UI device 15 includes a touch panel and a physical button set with a predetermined function, and receives an instruction input provided from a user. The scanner 16 reads a document loaded in the image forming apparatus 10 as image data. The print engine 17 prints an image on a recording medium such as a print sheet through processing including charging, exposure, development, transfer, and fixing, for example.

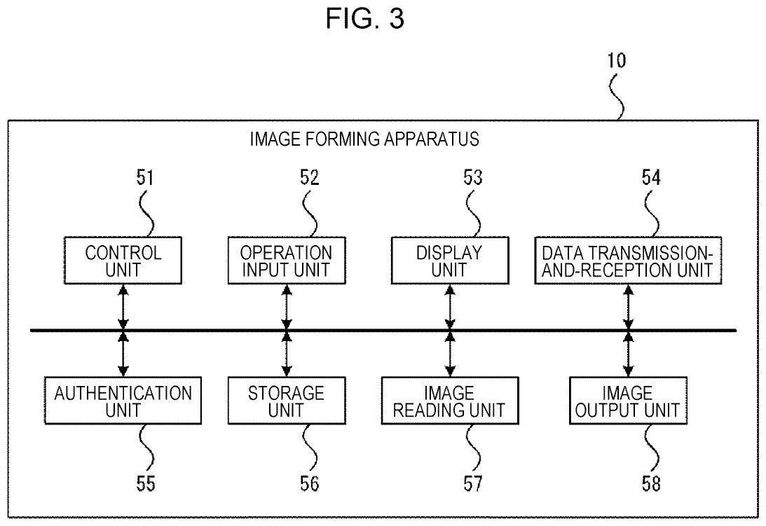

FIG. 3 is a block diagram illustrating a functional configuration of the image forming apparatus 10. As illustrated in FIG. 3, the image forming apparatus 10 according to the present exemplary embodiment includes a control unit 51, an operation input unit 52, a display unit 53, a data transmission-and-reception unit 54, an authentication unit 55, a storage unit 56, an image reading unit 57, and an image output unit 58.

The control unit 51 controls overall operation of the image forming apparatus 10, and, based on an instruction input provided from a user, performs control of causing the image reading unit 57 to read a document image and control of causing the image output unit 58 to output print data, for example.

The operation input unit 52 accepts inputted information of various types of operations performed by a user. The display unit 53 is controlled by the control unit 51 and displays various types of information to a user. The data transmission-and-reception unit 54 allows data to be transmitted to and received from an external device such as the user terminals 20. The authentication unit 55 executes authentication processing on a user attempting to utilize the image forming apparatus 10.

The storage unit 56 stores various types of data such as a program for controlling operation of the image forming apparatus 10. The image reading unit 57 reads a document image from a loaded document based on control by the control unit 51. Under the control by the control unit 51, the image output unit 58 outputs an image onto a recording medium such as a print sheet.

The image forming apparatus 10 according to the present exemplary embodiment is shared by a plurality of users. Each of the users requests a job from each of the user terminals 20, and, when his or her turn has come, moves to a position in front of the image forming apparatus 10, performs an authentication operation, and executes the requested job. Therefore, when the plurality of users have requested jobs, making the image forming apparatus 10 busy, one of the users, who is currently using the image forming apparatus 10, may feel a psychological burden.

In order to solve such a problem as described above, the control unit 51 in the image forming apparatus 10 according to the present exemplary embodiment transitions, when detecting requests for performing jobs from the plurality of users and detecting that there is busy, from a normal mode to a busy mode under which a number of operation procedures required from authentication of a user to execution of a job is smaller than a number of operation procedures required under the normal mode.

The normal mode is an example of a first operation mode in the technique of the present disclosure. Furthermore, the busy mode is an example of a second operation mode in the technique of the present disclosure.

For detecting that there is busy, the control unit 51 may determine that there is busy and may transition to the busy mode when a number of requested jobs is equal to or greater than a set threshold value, when a number of times of switching of authenticated users per a set period of time is equal to or greater than a set threshold value, or when a number of requested jobs per a set period of time is equal to or greater than a set threshold value.

In the image forming apparatus 10 according to the present exemplary embodiment, the control unit 51 may set, under the busy mode, a screen to be first displayed on the display unit 53 after a user has been authenticated to an operation screen for performing a job that the user has requested.

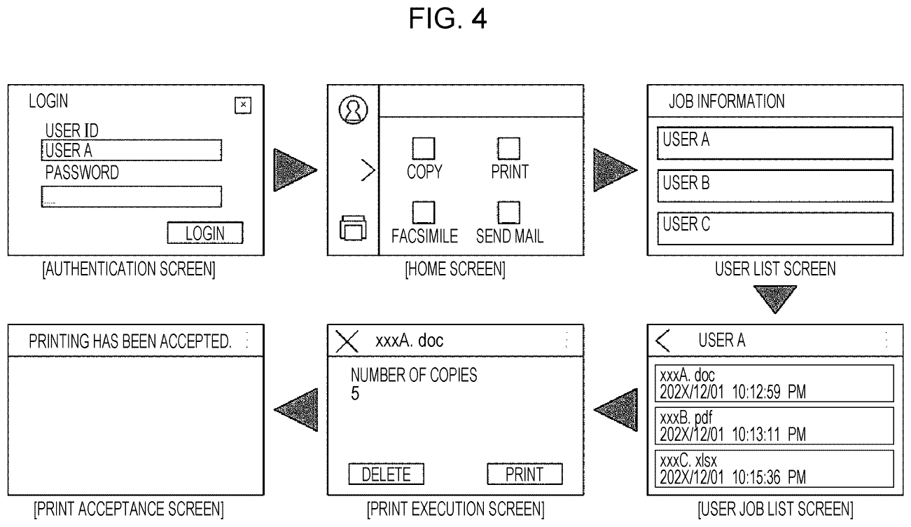

To describe a specific example, the control unit 51 causes, under the normal mode, as illustrated in FIG. 4, a home screen to be displayed as a screen to be first displayed on the display unit 53 after authentication on an authentication screen. Note that, in the technique of the present disclosure, the home screen is a basic screen to be displayed during normal operation, allowing various types of settings and various types of job selections to be performed.

On the home screen, for example, job icons for selecting various types of jobs, a job information display icon for displaying information of a job being requested, and the like are displayed. The icons are examples of operators in the technique of the present disclosure.

When a user desires to execute printing under the normal mode, the user first touches the job information display icon on the home screen to display a user list screen for displaying a list of users each currently requesting a job.

Next, the user touches a name of the user himself or herself on the user list screen to display a user job list screen for displaying a list of jobs that the user being authenticated has requested.

Next, the user touches a document desired to be printed on the user job list screen to display a print execution screen.

Finally, as the user touches a print icon on the print execution screen, a print acceptance screen is displayed, executing printing of the selected document.

As described above, it is necessary, under the normal mode, to undergo the three screens until the print execution screen is displayed after the user has performed authentication.

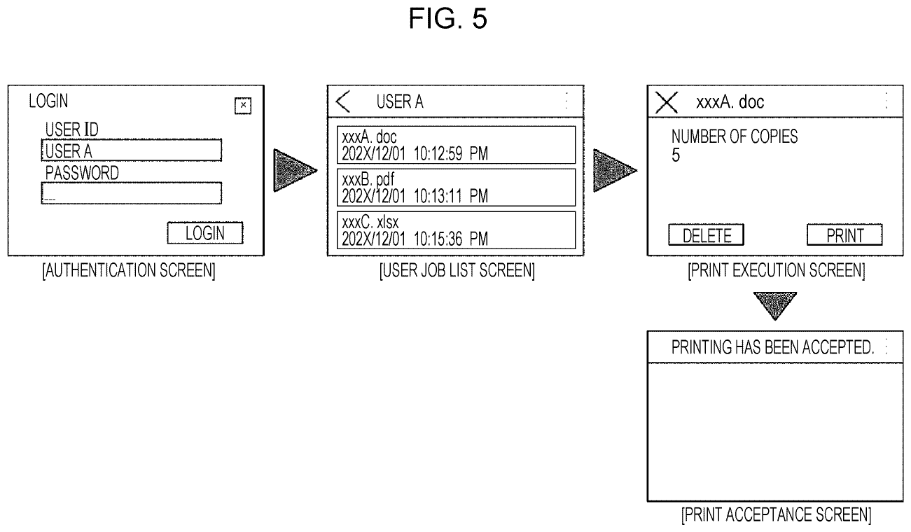

Under the busy mode, as illustrated in FIG. 5, on the other hand, the control unit 51 causes the display unit 53 to display the user job list screen for displaying a list of jobs that the user being authenticated has requested as a screen to be first displayed after authentication on the authentication screen.

The user touches a document desired to be printed on the user job list screen to display the print execution screen.

Next, as the user touches the print icon on the print execution screen, the print acceptance screen is displayed, executing printing of the selected document.

As described above, it is only necessary, under the busy mode, to undergo the one screen until the print execution screen is displayed after the user has performed authentication.

Note that, when there is only one job requested by a user being authenticated, the print execution screen may be directly displayed instead of the user job list screen as a screen to be first displayed on the display unit 53 after authentication.

Furthermore, although it is possible to prevent an unnecessary icon from being displayed on the home screen in order to achieve simplified display, the control unit 51 may cause, under the busy mode, an icon that is set to be hidden under the normal mode to be displayed on the home screen.

In this case, the control unit 51 may cause, under the busy mode, an icon set with a frequency of use, which is equal to or greater than a set threshold value, to be displayed on the home screen among icons that are set to be hidden under the normal mode.

Furthermore, the control unit 51 may cause, under the busy mode, an icon set in advance by a user to be displayed on the home screen among icons that are set to be hidden under the normal mode.

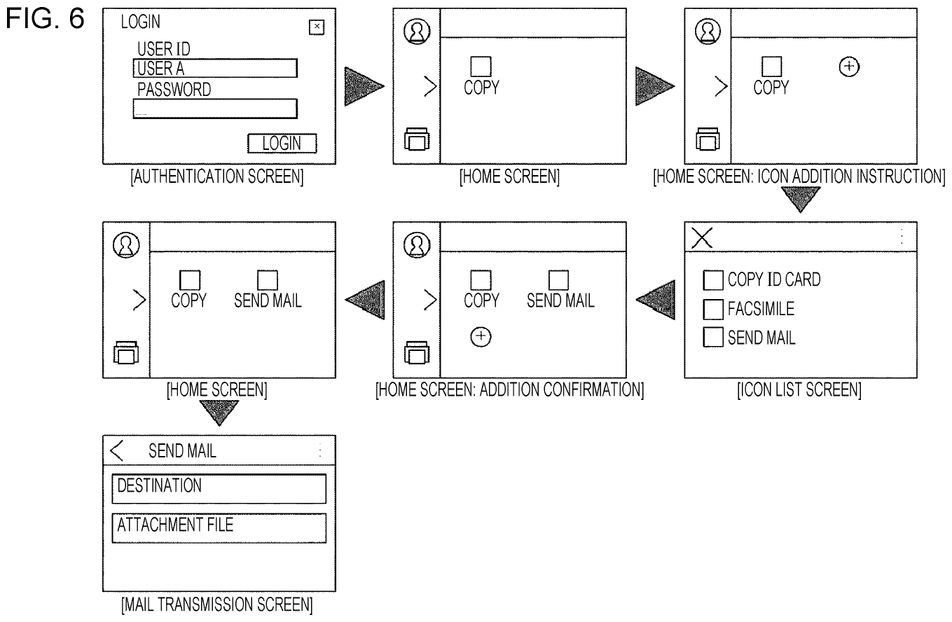

To describe a specific example, although the control unit 51 has caused only a copy icon to be displayed on the home screen under the normal mode as illustrated in FIG. 6, when the user desires to execute mail transmission, the user first inputs an icon addition instruction on the home screen to cause an icon list screen to be displayed.

Next, as the user touches a send mail icon as an icon to be added on the icon list screen and inputs a confirmation instruction on the home screen, the send mail icon is added on the home screen.

Finally, as the user touches the send mail icon on the home screen, a mail transmission screen for executing mail transmission is displayed.

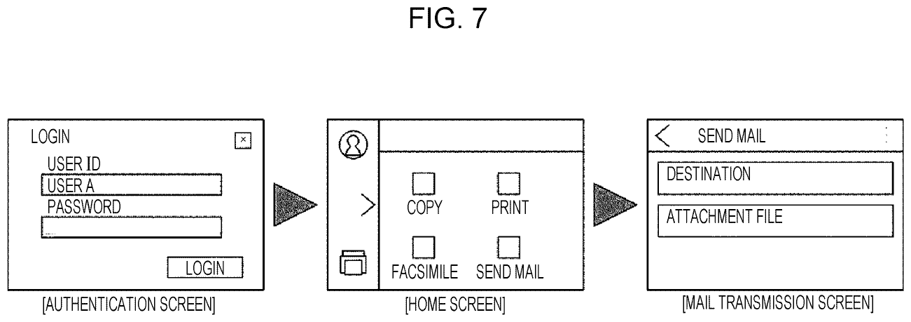

Under the busy mode, as illustrated in FIG. 7, on the other hand, the control unit 51 causes a print icon, a facsimile icon, and the send mail icon, which are set to be hidden, to be displayed on the home screen, in addition to the copy icon.

Thereby, even when the user desires to execute mail transmission, the icon of which has been set to be hidden under the normal mode, the user is able to immediately touch the send mail icon.

Furthermore, when a preview of a job is to be displayed under the busy mode, the control unit 51 may cause a simple preview having a lighter processing load than a load of a standard preview to be displayed under the normal mode to be displayed.

In this case, when a simple preview of a job is to be displayed under the busy mode, the control unit 51 may cause a simple preview having a lower resolution than a resolution of a standard preview to be displayed under the normal mode to be displayed.

Furthermore, when a preview of a job is to be displayed under the busy mode, the control unit 51 may cause a preview to be displayed in a form of layout display through which only a layout of a display image is displayed.

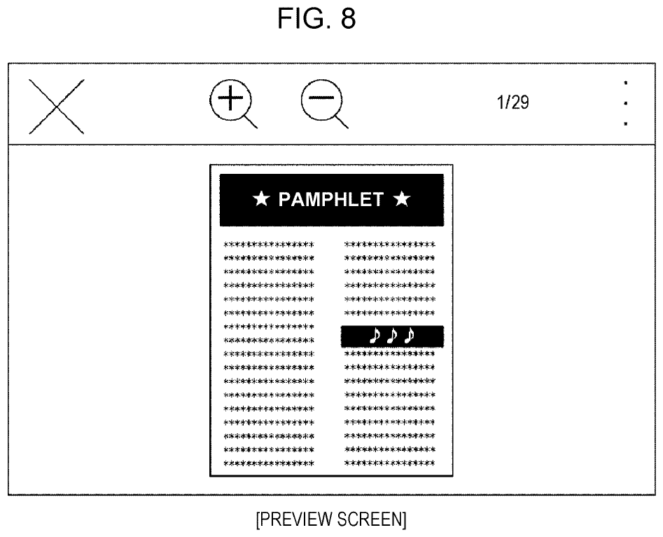

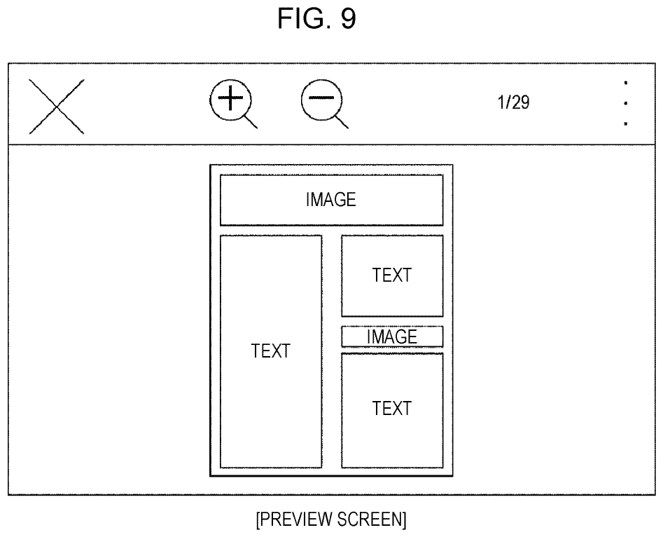

Note that layout display refers to a display aspect in which only a type such as text or a drawing and its display region are displayed. Specifically, when a preview of a document in which a drawing and text are mixed is displayed under the normal mode as illustrated in FIG. 8, only a type such as text or a drawing and its display region are displayed under the busy mode as illustrated in FIG. 9.

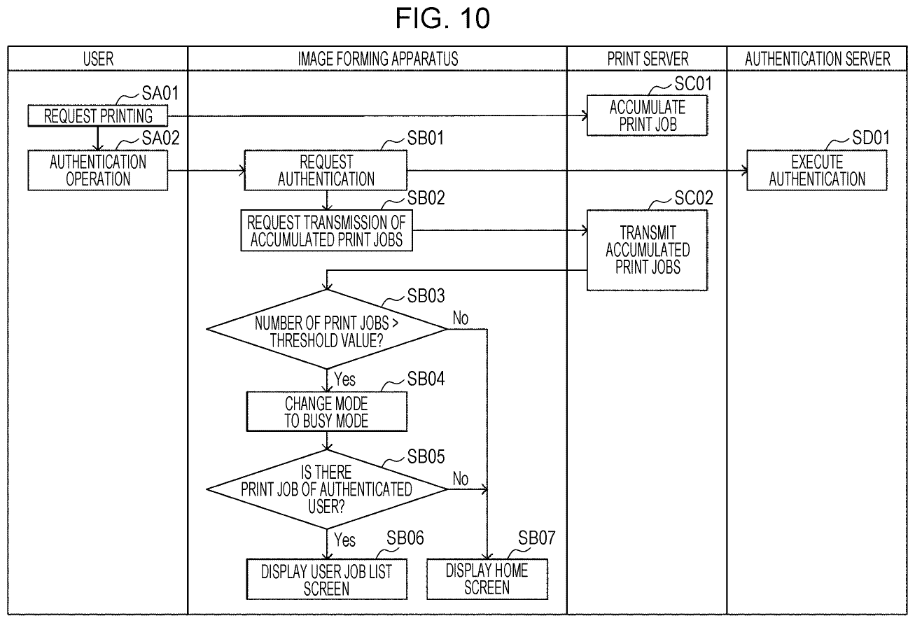

Next, a flow of processing when a job is executed in the image forming apparatus 10 according to the present exemplary embodiment will now be described herein with reference to the flowchart illustrated in FIG. 10.

As a user requests printing in step SA01, the print server 31 first accumulates a print job in step SC01.

Next, as the user performs an authentication operation from the image forming apparatus 10 in step SA02, the image forming apparatus 10 requests the authentication server 32 to authenticate the user in step SB01, and the authentication server 32 execute authentication on the user in step SD01.

Next, as the image forming apparatus 10 requests the print server 31 to transmit all accumulated print jobs of users in step SB02, the print server 31 transmits all the accumulated print jobs to the image forming apparatus 10 in step SC02.

Next, in step SB03, the image forming apparatus 10 determines whether or not a number of the received print jobs exceeds a threshold value.

When it is determined in step SB03 that the number of print jobs does not exceed the threshold value, the image forming apparatus 10 determines in step SB07 that there is not busy and causes the home screen to be displayed.

When it is determined in step SB03 that the number of print jobs exceeds the threshold value, the image forming apparatus 10 determines in step SB04 that there is busy and changes its mode from the normal mode to the busy mode.

Next, in step SB05, the image forming apparatus 10 determines whether or not there is a print job of the authenticated user.

When it is determined in step SB05 that there is a print job of the authenticated user, the image forming apparatus 10 causes the user job list screen to be displayed in step SB06.

When it is determined in step SB05 that there is no print job of the authenticated user, the image forming apparatus 10 causes the home screen to be displayed in step SB07.

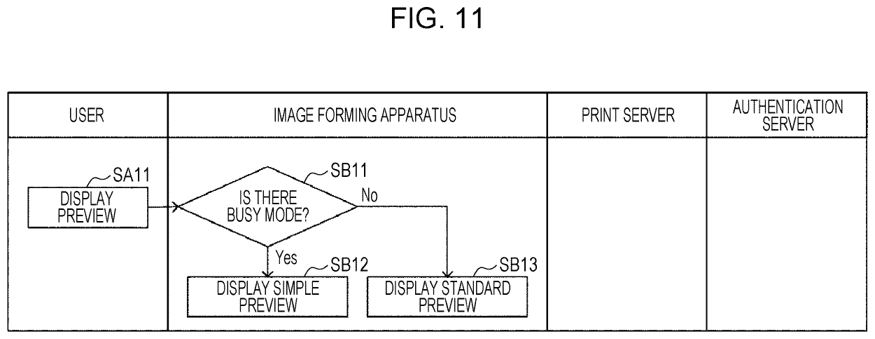

Next, a flow of processing when a preview is displayed in the image forming apparatus 10 according to the present exemplary embodiment will now be described herein with reference to the flowchart illustrated in FIG. 11.

As the user instructs to display a preview in step SA11, the image forming apparatus 10 first determines whether or not there has been the busy mode in step SB11.

When it is determined in step SB11 that there has been the busy mode, the image forming apparatus 10 causes a simple preview to be displayed in step SB12.

When it is determined in step SB11 that there has not been the busy mode, the image forming apparatus 10 causes a standard preview to be displayed in step SB13.

### MODIFICATION EXAMPLES

Although the image forming system according to the exemplary embodiment of the present disclosure has been described above, the technique of the present disclosure is not limited to the exemplary embodiment described above and is able to be appropriately modified.

In the exemplary embodiment described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the processor in the exemplary embodiment described above may be not only operations performed by one processor, but also operations performed, in cooperation with each other, by a plurality of processors that exist at physically distant positions. Furthermore, the order of the operations of the processor is not limited to the order described in the exemplary embodiment described above, and may be appropriately modified.

Furthermore, although the case where the technique of the present disclosure is applied to the image forming apparatus that is a multifunction machine has been described in the exemplary embodiment described above, the present disclosure is not limited to the exemplary embodiment, and is also able to be applied to various types of information processing systems such as a scanner or a printer.

### Appendix

(((1)))

An information processing system comprising a processor configured to transition, when requests for performing processing from a plurality of users have been detected, from a first operation mode to a second operation mode under which a number of operation procedures required from authentication of a user to execution of processing is smaller than a number of operation procedures required under the first operation mode.

(((2)))

The information processing system according to (((1))), wherein the processor is configured to transition to the second operation mode when a number of requested processing is equal to or greater than a set threshold value.

(((3)))

The information processing system according to (((1))), wherein the processor is configured to transition to the second operation mode when a number of times of switching of authenticated users per a set period of time is equal to or greater than a set threshold value.

(((4)))

The information processing system according to any one of (((1))) to (((3))), wherein, under the second operation mode, the processor is configured to set a screen to be first displayed on a display unit after a user has been authenticated to an operation screen for performing processing that the user has requested.

(((5)))

The information processing system according to any one of (((1))) to (((3))), wherein the processor is configured to cause, under the second operation mode, an operator that is set to be hidden under the first operation mode to be displayed on a home screen.

(((6)))

The information processing system according to (((5))), wherein the processor is configured to cause, under the second operation mode, an operator having a frequency of use equal to or greater than a set threshold value to be displayed the home screen among operators that are set to be hidden under the first operation mode.

(((7)))

The information processing system according to (((5))), wherein the processor is configured to cause, under the second operation mode, an operator set in advance by a user to be displayed the home screen among operators that are set to be hidden under the first operation mode.

(((8)))

The information processing system according to any one of (((1))) to (((7))), wherein, when a preview of processing is to be displayed under the second operation mode, the processor is configured to cause a preview having a lighter processing load than a load of a preview to be displayed under the first operation mode to be displayed.

(((9)))

The information processing system according to (((8))), wherein, when a preview of processing is to be displayed under the second operation mode, the processor is configured to cause a preview having a lower resolution than a resolution of a preview to be displayed under the first operation mode to be displayed.

(((10)))

The information processing system according to (((8))), wherein, when a preview of processing is to be displayed under the second operation mode, the processor is configured to cause a preview to be displayed in a form of layout display through which only a layout of a display image is displayed.

(((11)))

A program causing a computer to execute a process comprising, when requests for performing processing from a plurality of users have been detected, transitioning from a first operation mode to a second operation mode under which a number of operation procedures required from authentication of a user to execution of processing is smaller than a number of operation procedures required under the first operation mode.

(((12)))

A control method comprising transitioning, when requests for performing processing from a plurality of users have been detected, from a first operation mode to a second operation mode under which a number of operation procedures required from authentication of a user to execution of processing is smaller than a number of operation procedures required under the first operation mode.

What is claimed is:

1. An information processing system comprising:
a processor configured to transition, when requests for performing processing from a plurality of users have been detected, from a first operation mode to a second operation mode under which a number of operation procedures required from authentication of a user to execution of processing is smaller than a number of operation procedures required under the first operation mode.

2. The information processing system according to claim 1, wherein the processor is configured to transition to the second operation mode when a number of requested processing is equal to or greater than a set threshold value.

3. The information processing system according to claim 1, wherein the processor is configured to transition to the second operation mode when a number of times of switching of authenticated users per a set period of time is equal to or greater than a set threshold value.

4. The information processing system according to claim 1, wherein, under the second operation mode, the processor is configured to set a screen to be first displayed on a display unit after a user has been authenticated to an operation screen for performing processing that the user has requested.

5. The information processing system according to claim 1, wherein the processor is configured to cause, under the second operation mode, an operator that is set to be hidden under the first operation mode to be displayed on a home screen.

6. The information processing system according to claim 5, wherein the processor is configured to cause, under the second operation mode, an operator having a frequency of use equal to or greater than a set threshold value to be displayed the home screen among operators that are set to be hidden under the first operation mode.

7. The information processing system according to claim 5, wherein the processor is configured to cause, under the second operation mode, an operator set in advance by a user to be displayed the home screen among operators that are set to be hidden under the first operation mode.

8. The information processing system according to claim 1, wherein, when a preview of processing is to be displayed under the second operation mode, the processor is configured to cause a preview having a lighter processing load than a load of a preview to be displayed under the first operation mode to be displayed.

9. The information processing system according to claim 8, wherein, when a preview of processing is to be displayed under the second operation mode, the processor is configured to cause a preview having a lower resolution than a resolution of a preview to be displayed under the first operation mode to be displayed.

10. The information processing system according to claim 8, wherein, when a preview of processing is to be displayed under the second operation mode, the processor is configured to cause a preview to be displayed in a form of layout display through which only a layout of a display image is displayed.

11. A non-transitory computer readable medium storing a program causing a computer to execute a process comprising:
when requests for performing processing from a plurality of users have been detected, transitioning from a first operation mode to a second operation mode under which a number of operation procedures required from authentication of a user to execution of processing is smaller than a number of operation procedures required under the first operation mode.

12. A control method comprising:
transitioning, when requests for performing processing from a plurality of users have been detected, from a first operation mode to a second operation mode under which a number of operation procedures required from authentication of a user to execution of processing is smaller than a number of operation procedures required under the first operation mode.
